(19) United States
(12) Patent Application Publication
(10) Pub. No.: US 2023/0219825 A1
(43) Pub. Date: Jul. 13, 2023

(54) COBALT-COATED NICKEL-CONTAINING HYDROXIDE PARTICLES

(71) Applicant: TANAKA CHEMICAL CORPORATION, Fukui (JP)

(72) Inventors: Naoya Hanamura, Fukui (JP); Naotoshi Satomi, Fukui (JP); Mikio Hata, Fukui (JP)

(73) Assignee: TANAKA CHEMICAL CORPORATION, Fukui (JP)

(21) Appl. No.: 18/009,139

(22) PCT Filed: May 17, 2021
(86) PCT No.: PCT/JP2021/018522

§ 371 Date: Dec. 8, 2022

(30) Foreign Application Priority Data
Jun. 18, 2020 (JP) 2020-105575
Dec. 24, 2020 (JP) 2020-215563

(51) Int. Cl. C01G 53/00; H01M 10/054

(52) U.S. Cl. CPC C01G 53/40; H01M 10/054; C01P 2004/51; C01P 2006/40

(57) ABSTRACT

The nickel-containing hydroxide particle covered with cobalt, wherein in a volume-based particle size distribution, the nickel-containing hydroxide particle covered with cobalt has the maximum peak with a height a, one peak at a height of (½)a or higher, and has a value A of formula (1) calculated from a width b of the maximum peak at a height of (½)a, and in a volume-based particle size distribution after compression treatment, the nickel-containing hydroxide particle covered with cobalt has the maximum peak with a height c, and has a value B of formula (2) calculated from a width d of the maximum peak at a height of (½)c, and wherein the value B and the value A have a relation represented by formula (3):

A=[(b×(½)a]/2 (1)

B=[(d×(½)c]/2 (2)

−1.50≤[(B−A)/A]×1005.00 (3)

### CROSS REFERENCE TO RELATED APPLICATIONS

The present application is a by-pass continuation application of International Patent Application No. PCT/JP2021/018522 filed on May 17, 2021, which claims the benefit of Japanese Patent Application No. 2020-105575, filed on Jun. 18, 2020, and Japanese Patent Application No. 2020-215563, filed on Dec. 24, 2020. The contents of these applications are incorporated herein by reference in their entirety.

### BACKGROUND

### 1. Technical Field of the Disclosure

The present disclosure relates to a nickel-containing hydroxide particle covered with cobalt capable of reducing volume resistivity due to nickel-containing hydroxide particles being prevented from aggregation when a cobalt covering of the nickel-containing hydroxide particle undergoes oxidation treatment, and of improving battery characteristics when used as a positive electrode active material in secondary batteries.

### 2. Background

In recent years, improvements in battery characteristics of secondary batteries such as nickel metal hydride secondary batteries, have been increasingly demanded attendant on enhanced functionality of equipment and the like. Therefore, in nickel hydroxide particles covered with a cobalt compound for positive electrode active materials of secondary batteries, a nickel-containing composite hydroxide particle with a higher cobalt content has been developed in order to improve battery characteristics.

Moreover, a covering layer with a high cobalt compound content is also formed on a nickel hydroxide particle in order to increase the cobalt content. As the nickel hydroxide particle having a covering layer of the cobalt compound formed thereon, for example, covered nickel hydroxide powder for positive electrode active materials of alkaline secondary batteries in which a particle surface of the nickel hydroxide powder is covered with cobalt oxyhydroxide or a cobalt compound composed mainly of a mixture of cobalt oxyhydroxide and cobalt hydroxide in order to ensure uniformity and adhesiveness of the covering layer, characterized in that the cobalt in the covering has a valence number of 2.5 or higher, and an amount of peeling of the covering is 20% by mass or less of the total covering amount when 20 g of the covered nickel hydroxide powder is shaken for 1 hour in an air-tight container, has been proposed (Japanese Patent Application Publication No. 2014-103127).

On the other hand, due to the further advancement such as enhanced functionality of equipment in which a secondary battery such as a nickel metal hydride secondary battery is mounted, the secondary battery mounted is required to exhibit excellent characteristics even under severe environments such as high temperatures or under high load. When a secondary battery such as a nickel metal hydride secondary battery undergoes evaluation for its charge/discharge capacity at high temperatures, the electrical conductivity of a positive electrode active material may be deteriorated, resulting in a loss of excellent charge/discharge capacity. Therefore, the positive electrode active material is required to prevent the electrical conductivity from deteriorating even when the secondary battery such as a nickel metal hydride secondary battery is exposed to severe environments such as high temperatures or under high load.

However, the covered nickel hydroxide powder for positive electrode active materials of alkaline secondary batteries of Japanese Patent Application Publication No. 2014-103127 may deteriorate the electrical conductivity of the positive electrode active material upon application of charge/discharge with high load, which leaves room for improvement in enhancing electrical conductivity as a positive electrode active material.

### SUMMARY

In view of the circumstances, it is an object of the present disclosure to provide a nickel-containing hydroxide particle covered with cobalt, capable of reducing volume resistivity due to the nickel-containing hydroxide particles being prevented from aggregation when a cobalt covering of the nickel-containing hydroxide particle undergoes oxidation treatment.

The gist of the configuration of the present disclosure is as follows: [1] A nickel-containing hydroxide particle covered with cobalt, including a covering layer containing cobalt oxyhydroxide as a major component formed on a nickel-containing hydroxide particle, wherein the nickel-containing hydroxide particle contains nickel (Ni), zinc (Zn), and one or more additive metal elements M selected from the group consisting of cobalt (Co) and magnesium (Mg), and a ratio by molar % of nickel:zinc:additive metal element M is 100-x-y:x:y, where 1.50×9.00 and 0.00≤y≤3.00, in a volume-based particle size distribution by a laser diffraction scattering method, the nickel-containing hydroxide particle covered with cobalt has the maximum peak with a height a, and one peak at a height of (½)a or higher, and has a value A of the following formula (1) calculated from a width b of the maximum peak at a height of (½)a, and

in a volume-based particle size distribution by the laser diffraction scattering method after compression treatment at a pressing pressure of 64 MPa, the nickel-containing hydroxide particle covered with cobalt has the maximum peak with a height c, and has a value B of the following formula (2) calculated from a width d of the maximum peak at a height of (½)c, and

wherein the value B and the value A have a relation represented by the following formula (3):

A=[(b×(½)a]/2 (1)

B=[(d×(½)c]/2 (2)

−1.50≤[(B−A)/A]×100≤5.00 (3)

[2] The nickel-containing hydroxide particle covered with cobalt according to [1], having one peak in a volume-based particle size distribution before the compression treatment.

[3] The nickel-containing hydroxide particle covered with cobalt according to [1] or

[2], wherein a volume resistivity is 0.40 Ω·cm or higher and 1.20 Ω·cm or lower.

[4] The nickel-containing hydroxide particle covered with cobalt according to any one of [1] to [3], wherein the covering layer containing cobalt oxyhydroxide further contains cobalt oxide.

[5] The nickel-containing hydroxide particle covered with cobalt according to any one of [1] to [4], wherein the nickel-containing hydroxide particle contains zinc.

[6] The nickel-containing hydroxide particle covered with cobalt according to any one of [1] to [5], which is for a positive electrode active material of a nickel metal hydride secondary battery.

[7] A positive electrode having the nickel-containing hydroxide particle covered with cobalt according to any one of [1] to [6] and a metal foil current collector.

[8] A nickel metal hydride secondary battery including the positive electrode according to [7].

In the nickel-containing hydroxide particle covered with cobalt of the present disclosure, the nickel-containing hydroxide particle has a covering layer, and the covering layer contains a cobalt compound.

In an aspect of [1] above, the “volume-based particle size distribution by a laser diffraction scattering method” refers to a volume-based particle size distribution measured by using the laser diffraction scattering method under the conditions of a solvent: water, a solvent refractive index: 1.33, a particle refractive index: 2.13, a transmittance: 80±5%, and a dispersion medium: 10.0 wt % of a sodium hexametaphosphate aqueous solution. Moreover, the “compression treatment at a pressing pressure of 64 MPa” refers to compression treatment wherein 3.00 g of a sample was put in a sample feed cell with a radius of 10 mm and subjected to compression treatment with a load of 20 kN of force applied to the cell.

Moreover, in an aspect of [1] above, the maximum peak of the nickel-containing hydroxide particle covered with cobalt before the compression treatment has one peak in the region with a height of ½ or higher the height a of the maximum peak, which is not in a separated form.

According to the nickel-containing hydroxide particle covered with cobalt of the present disclosure, the nickel-containing hydroxide particle contains nickel, zinc, and one or more additive metal elements M selected from the group consisting of cobalt and magnesium, and a ratio by molar % of nickel:zinc:additive metal element M is 100-x-y:x:y (where 1.50≤x≤9.00, 0.00≤y≤3.00), and in the volume-based particle size distribution by the laser diffraction scattering method, the nickel-containing hydroxide particle covered with cobalt has the maximum peak with a height a, and one peak at a height of (½)a or higher, and has a value A of the following formula (1) calculated from a width b of the maximum peak at a height of (½)a, and in a volume-based particle size distribution by the laser diffraction scattering method after compression treatment at a pressing pressure of 64 MPa, the nickel-containing hydroxide particle covered with cobalt has the maximum peak with a height c, and has a value B of the following formula (2) calculated from a width d of the maximum peak at a height of (½)c, and wherein the value B and the value A have a relation represented by the following formula (3):

A=[(b×(½)a]/2 (1)

B=[(d×(½)c]/2 (2)

−1.50≤[(B−A)/A]×100≤5.00 (3),

thereby enabling a nickel-containing hydroxide particle covered with cobalt in which a cobalt covering is sufficiently oxidized while the nickel-containing hydroxide particles are prevented from aggregation when the cobalt covering of the nickel-containing hydroxide particle undergoes oxidation treatment, thereby having reduced volume resistivity, to be obtained.

Accordingly, even under the conditions that a positive electrode active material using the nickel-containing hydroxide particle covered with cobalt of the present disclosure is mounted in a secondary battery, and the secondary battery operates in severe environments such as high temperatures and even under high load, the nickel-containing hydroxide particle covered with cobalt of the present disclosure can prevent the electrical conductivity of the positive electrode active material from its deterioration, thereby enabling excellent battery characteristics to be exhibited.

According to the nickel-containing hydroxide particle covered with cobalt of the present disclosure, the volume resistivity is 1.20 Ω·cm or less, which enables a positive electrode active material to reliably exhibit excellent electrical conductivity even under the conditions that a secondary battery operates under severe environments such as high temperatures and even under high load, therefore enabling excellent battery characteristics to be more reliably exhibited.

### BRIEF DESCRIPTION OF THE DRAWINGS

FIG. 1 is an explanatory diagram of a region indicated by value A in formula (1) in a volume-based particle size distribution diagram of the nickel-containing hydroxide particle covered with cobalt of the present disclosure.

FIG. 2 is a volume-based particle size distribution diagrams in the nickel-containing hydroxide particles covered with cobalt of Examples and Comparative Examples, which are obtained by a laser diffraction scattering method.

### DETAILED DESCRIPTION OF THE PREFERRED EMBODIMENTS

Hereinafter, the nickel-containing hydroxide particle covered with cobalt of the present disclosure will be described in detail. In the nickel-containing hydroxide particle covered with cobalt of the present disclosure, a covering layer of a cobalt compound is formed on a surface of the nickel-containing hydroxide particle. Namely, the nickel-containing hydroxide particle is a core particle, and the core particle is covered with a layer of the cobalt compound (shell structure), for example, a layer of a cobalt compound in which cobalt mainly has a valence number of 3. The cobalt compounds in which cobalt has a valence number of 3 include cobalt oxyhydroxide. From the above, the nickel-containing hydroxide particle covered with cobalt of the present disclosure is a particle in which a covering layer containing cobalt oxyhydroxide is formed on the nickel-containing hydroxide particle.

A shape of the nickel-containing hydroxide particle covered with cobalt is not particularly limited, but includes, for example, a substantially spherical shape. Moreover, the nickel-containing hydroxide particle is, for example, in an aspect of a secondary particle formed from a plurality of primary particles. A covering layer containing cobalt oxyhydroxide of the nickel-containing hydroxide particle covered with cobalt may cover the entire surface of the nickel-containing hydroxide particle or may cover a partial region of a surface of the nickel-containing hydroxide particle.

In a volume-based particle size distribution by a laser diffraction scattering method, the nickel-containing hydroxide particle covered with cobalt of the present disclosure has the maximum peak with a height a, and one peak at a height of (½)a or higher, and has a value A of the following formula (1) calculated from a width b of the maximum peak at a height of (½)a.

A=[(b×(½)a]/2 (1)

The nickel-containing hydroxide particle covered with cobalt of the present disclosure is used, for example, as a positive electrode active material for a nickel metal hydride secondary battery. Therefore, the nickel-containing hydroxide particle covered with cobalt of the present disclosure, which is a product used as the positive electrode active material, has the maximum peak height (i.e., maximum frequency) a in a volume-based particle size distribution diagram by the laser diffraction scattering method, and has only one peak in the region where a peak height (frequency) is (½)a or higher the maximum peak height. Moreover, in the above-described volume-based particle size distribution diagram, the nickel-containing hydroxide particle covered with cobalt has a width b of the maximum peak at a height of (½)a, and has value A of formula (1) calculated from height a of the maximum peak and width b of the maximum peak. Value A of formula (1) above indicates the area size of the region with ½ or higher the height of the maximum peak with respect to the maximum peak in a volume-based particle size distribution diagram of the nickel-containing hydroxide particle covered with cobalt of the present disclosure that is a product.

Moreover, in a volume-based particle size distribution by the laser diffraction scattering method after compression treatment at a pressing pressure of 64 MPa, the nickel-containing hydroxide particle covered with cobalt of the present disclosure has the maximum peak with a height c (i.e., maximum frequency), and has a value B of the following formula (2) calculated from a width d of the maximum peak at a height (frequency) of (½)c. Value B of the following formula (2) indicates the area size of the region with ½ or higher the height of the maximum peak with respect to the maximum peak in the volume-based particle size distribution diagram obtained after the compression treatment of the nickel-containing hydroxide particle covered with cobalt of the present disclosure.

B=[(d×(½)c]/2 (2)

The nickel-containing hydroxide particle covered with cobalt of the present disclosure has a different shape of the maximum peak in a volume-based particle size distribution diagram by the laser diffraction scattering method before or after the compression treatment at a pressing pressure of 64 MPa.

As will be described below, the nickel-containing hydroxide particle covered with cobalt of the present disclosure can be obtained by forming a covering layer containing cobalt on a surface of the nickel-containing hydroxide particle that is the core particle to obtain a nickel-containing hydroxide particle having a covering layer formed thereon, thereafter adding an alkali solution to the nickel-containing hydroxide particle having a covering layer formed thereon and undergoing oxidation treatment of the cobalt contained in the covering layer to cobalt oxyhydroxide.

In a case in which the cobalt contained in a covering layer undergoes oxidation treatment by adding an alkali solution to the nickel-containing hydroxide particle having a covering layer formed thereon, and the cobalt contained in the covering layer is not sufficiently oxidized due to the insufficient amount of the alkali solution added or the like, aggregation of the nickel-containing hydroxide particles having the covering layers formed thereon hardly occurs, however, the cobalt oxyhydroxide is not sufficiently oxidized, thereby deteriorating the electrical conductivity of the positive electrode active material. On the other hand, in the case in which the cobalt contained in the covering layer is oxidized by adding an alkali solution to the nickel-containing hydroxide particle having a covering layer formed thereon, the excessive amount of the alkali solution added accelerates oxidation of the cobalt contained in the covering layer, however, facilitates aggregation of the nickel-containing hydroxide particles having a covering layer formed thereon by an action of the alkali solution. When the nickel-containing hydroxide particles having a covering layer formed thereon aggregate, an aggregated portion where the nickel-containing hydroxide particles having a covering layer formed thereon contact with each other, is formed. The covering layer is not exposed at the aggregated portion, thereby preventing the cobalt contained in the covering layer from oxidation thereof. When the aggregated nickel-containing hydroxide particles covered with cobalt, for example, the nickel-containing hydroxide particles covered with cobalt aggregated before or after being mounted to the positive electrode, crack and the aggregated portion is exposed, which results in deterioration of the electrical conductivity of the positive electrode active material. Moreover, the nickel-containing hydroxide particles having a covering layer formed thereon in aggregated form, lowers handleability upon filling the nickel-containing hydroxide particles covered with cobalt into a positive electrode collector as the positive electrode active material, which may affect properties of a positive electrode and, ultimately, battery properties.

The present inventors have found that the degree of aggregation and the degree of oxidation in the oxidation treatment of the nickel-containing hydroxide particle having a covering layer formed thereon could be measured by subjecting the nickel-containing hydroxide particle covered with cobalt obtained as a product to compression treatment at a pressing pressure of 64 MPa and analyzing the difference in the maximum peaks of volume-based particle size distributions by the laser diffraction scattering method, obtained before and after the compression treatment.

Specifically, the present inventors have found that in analyzing the difference in the maximum peaks of the volume-based particle size distributions as described above, analyzing a difference in areas of each region where with ½ or higher the height of the maximum peak with respect to the maximum peak in the volume-based particle size distribution diagram, enabled measurement of the degree of aggregation and the degree of oxidation in the oxidation treatment of the nickel-containing hydroxide particle having a covering layer formed thereon. The reason why the analysis of the difference in areas of each region with ½ or higher the height of the maximum peak of the nickel-containing hydroxide particle covered with cobalt, enabling measurement of the degree of aggregation and the degree of oxidation in the oxidation treatment of the nickel-containing hydroxide particle having a covering layer formed thereon, is conjectured because the area of the region with ½ or higher the height of the maximum peak indicates reaction efficiency between the nickel-containing hydroxide particle covered with cobalt and the alkali solution.

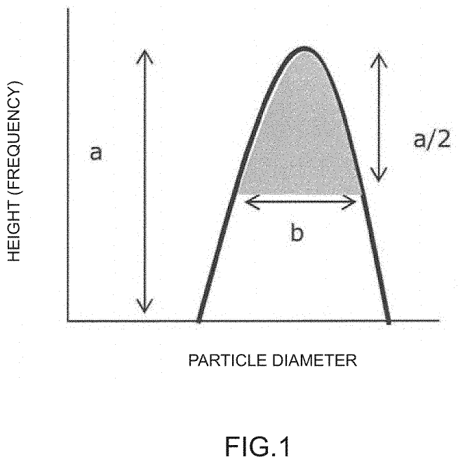

FIG. 1 shows the area of the region where a peak height (frequency) is ½ or higher the maximum peak height, as described above, with respect to the maximum peak in the volume-based particle size distribution. FIG. 1 is an explanatory diagram illustrating an outline of value A of formula (1) in the volume-based particle size distribution diagram of the nickel-containing hydroxide particle covered with cobalt of the present disclosure. In FIG. 1, the nickel-containing hydroxide particle covered with cobalt of the present disclosure has one peak in the volume-based particle size distribution. Value B of formula (2) can also be shown in the same manner as in FIG. 1, for an area of a region with ½ or higher the height of the maximum peak.

Moreover, the present inventors also have found that in the case of the amount of an alkali solution added being excessive, aggregation of the nickel-containing hydroxide particles having a covering layer formed thereon proceeded in oxidation treatment, as a result of which a plurality of peaks may have been present as the maximum peaks in an area with ½ or higher the height of the maximum peak. Namely, the present inventors have found that preventing addition of an excessive amount of the alkali solution resulted in having only one peak of the maximum peak in a region with ½ or higher the height of the maximum peak.

It is conjectured that when the cobalt contained in the covering layer is not sufficiently oxidized due to insufficient addition of the alkali solution or the like, the nickel-containing hydroxide particles having a covering layer formed thereon less aggregate, however, the nickel-containing hydroxide particles having a covering layer in which the cobalt is insufficiently oxidized adhere to each other and are difficult to be dispersed, whereby an area of a region with ½ or higher the height of the maximum peak is significantly reduced or significantly increased by the compression treatment. It is conjectured, on the other hand, that when the cobalt contained in the covering layer is oxidized by addition of an alkali solution and the amount of the alkali solution added becomes excessive, the nickel-containing hydroxide particles having a covering layer formed thereon facilitate aggregation, whereby the particles aggregated by the above-described compression treatment break into plural pieces mainly at the aggregated portion, resulting in a significant decrease or increase in an area of a region with ½ or higher the height of the maximum peak by the compression treatment.

From the above, in the nickel-containing hydroxide particle covered with cobalt of the present disclosure, value A calculated by formula (1) before the compression treatment at a pressing pressure of 64 MPa, and value B calculated by formula (2) after the compression treatment at a pressing pressure of 64 MPa, have the relation represented by the following formula (3). Namely, a change in an area of the maximum peak before or after the compression treatment at a pressing pressure of 64 MPa in a volume-based particle size distribution diagram by the laser diffraction scattering method is controlled so as to be within the range of the following formula (3). The following formula (3) refers a relative error between value A before the compression treatment at a pressing pressure of 64 MPa and value B after the compression treatment at a pressing pressure of 64 MPa.

−1.50≤[(B−A)/A]×100≤5.00 (3)

Value A calculated by formula (1) before the compression treatment at a pressing pressure of 64 MPa and value B calculated by formula (2) after the compression treatment at a pressing pressure of 64 MPa, have the relation represented by the formula (3) above, i.e., the value of [(B−A)/A]×100 is in the range of 1.5 or more and 5.00 or less, thereby indicating that in the case of the cobalt covering of the nickel-containing hydroxide particle being subjected to oxidation treatment, the cobalt covering is sufficiently oxidized to form cobalt oxyhydroxide while the nickel-containing hydroxide particles are prevented from aggregation, thereby enabling to obtain a nickel-containing hydroxide particle covered with cobalt, having reduced volume resistivity. Accordingly, even under the conditions where a positive electrode active material using the nickel-containing hydroxide particle covered with cobalt of the present disclosure is mounted on a secondary battery and the secondary battery can operate under severe environments such as high temperatures and under high load, the positive electrode active material can prevent the electrical conductivity from its deterioration, thereby enabling the secondary battery to exhibit excellent battery characteristics.

The value of [(B−A)/A]×100, calculated by formula (3), is not particularly limited as long as the value is in the range of −1.50 or more and 5.00 or less, and the lower limit value thereof is preferably −1.40 and particularly preferably −1.30 from the viewpoint that the cobalt covering is more perfectly oxidized to form cobalt oxyhydroxide while nickel-containing hydroxide particles is more reliably prevented from aggregation. The upper limit value of [(B−A)/A]×100, calculated by formula (3) is, on the other hand, preferably 4.50, more preferably 3.00, and particularly preferably 1.50. The upper limit values and the lower limit values described above can arbitrarily be combined.

A shape of the volume-based particle size distribution diagram by the laser diffraction scattering method is not particularly limited, and is preferably a shape with one peak in a volume-based particle size distribution from the viewpoint of improving the mounting density of the positive electrode active material in the positive electrode.

The volume resistivity of the nickel-containing hydroxide particle covered with cobalt of the present disclosure is not particularly limited, and from the viewpoint of improving more reliably the electrical conductivity of the nickel-containing hydroxide particle covered with cobalt, the volume resistivity is preferably 1.20 Ω·cm or lower, more preferably 1.10 Ω·cm or lower, and particularly preferably 1.00 Ω·cm or lower. The lower limit value of the volume resistivity of the nickel-containing hydroxide particle covered with cobalt is, on the other hand, preferably as low as possible. Examples of the lower limit value of the volume resistivity of the nickel-containing hydroxide particle covered with cobalt include, for example, 0.40 Ω·cm. Even under the conditions that the nickel-containing hydroxide particle covered with cobalt of the present disclosure is mounted on a secondary battery as a positive electrode active material, and the secondary battery operates under severe environments such as high temperatures and under high load, improving more reliably the electrical conductivity of the nickel-containing hydroxide particle covered with cobalt of the present disclosure enables the positive electrode active material to more definitely exhibit excellent electrical conductivity, thereby enabling the secondary battery to more definitely exhibit excellent battery characteristics.

Moreover, the covering layer containing cobalt oxyhydroxide of the nickel-containing hydroxide particle covered with cobalt of the present disclosure may further contain cobalt oxide. Containing further cobalt oxide in the covering layer containing cobalt oxyhydroxide indicates that when in the case of adding an alkali solution to the nickel-containing hydroxide particle having a covering layer formed thereon and oxidizing the cobalt contained in the covering layer, the excessive amount of the alkali solution added prevents the nickel-containing hydroxide particles having a covering layer formed thereon from facilitating its aggregation.

The nickel-containing hydroxide particle that is the core particle, is a hydroxide particle containing nickel and further contains zinc (Zn) in terms of obtaining its high utilization rate and excellent charge/discharge characteristics. Moreover, the zinc contained in the nickel-containing hydroxide particle is preferably in a state of solid-solubilized zinc. From the above, the nickel-containing hydroxide particle that is the core particle is a particle of nickel hydroxide in which zinc is solid-solubilized in the particle, i.e., a nickel-containing composite hydroxide particle.

The nickel-containing hydroxide particle that is the core particle may undergo solid solution formation, if necessary, with not only zinc (Zn), but also cobalt (Co) or magnesium (Mg) in terms of prolonging life of the nickel-containing hydroxide particle, or the like.

Where the nickel-containing hydroxide particle contains solid-solubilized cobalt, at least a moiety of the solid-solubilized cobalt is preferably trivalent cobalt in terms of further improvements in the electrical conductivity of the nickel-containing hydroxide particle. The trivalent cobalt solid-solubilized in the nickel-containing hydroxide particle includes, for example, cobalt oxyhydroxide.

The nickel-containing hydroxide particle that is the core particle include a nickel-containing hydroxide particle containing nickel (Ni) and zinc (Zn), and one or more additive metal elements M selected from the group consisting of cobalt (Co) and magnesium (Mg), and the ratio by molar % of nickel:zinc:additive metal element M is 100-x-y:x:y (where 1.50≤x≤9.00, 0.00≤y≤3.00). Additive metal element M is preferably solid-solubilized in the nickel-containing hydroxide particle. The value of x is not particularly limited as long as the value is 1.50 or more and 9.00 or less, and the value is preferably 1.60 or more and 5.00 or less, more preferably 1.70 or more and 4.00 or less, and particularly preferably 1.80 or more and 3.00 or less. Moreover, the value of y is not particularly limited as long as the value is 0.00 or more and 3.00 or less, and the value is preferably 0.00 or more and 2.50 or less, still more preferably 0.00 or more and 2.25 or less, and particularly preferably 0.00 or more and 2.00 or less, from the viewpoint that additive metal element M in the core particle does not prevent the covering layer from oxidation in an oxidation step, thereby enabling the oxidation treatment to be performed at high temperatures. The value of 100-x-y, which is the ratio by molar % of nickel, the value associated with a battery capacity, is not particularly limited as long as the value is 88.00 or more and 98.5 or less, and the value is more preferably 92.00 or more and 98.40 or less, still more preferably 93.00 or more and 98.30 or less, and particularly preferably 94.00 or more and 98.20 or less.

Examples of a method for analyzing metal elements in the nickel-containing hydroxide particle include analysis by ICP (inductively coupled plasma) emission spectrometry or the like. Moreover, examples of a method for analyzing metal elements contained in the core particle after cobalt covering include, for example, a method for cutting the nickel-containing hydroxide particle covered with cobalt and conducting EDX (energy dispersive X-ray) analysis on a core particle portion of a cross-section of the particle, or the like.

The cobalt oxyhydroxide contained in the covering layer has a diffraction peak between 650 and 66° of diffraction angles represented by 20 in a diffraction pattern obtained by X-ray diffraction measurement.

The content of nickel in the nickel-containing hydroxide particle in the nickel-containing hydroxide particle covered with cobalt is not particularly limited, but the lower limit value thereof is preferably 40% by mass, more preferably 45% by mass, and particularly preferably 50% by mass. The upper limit value of the content of nickel in the nickel-containing hydroxide particle in the nickel-containing hydroxide particle covered with cobalt is, on the other hand, preferably 65% by mass and particularly preferably 60% by mass. The lower limit values and the upper limit values described above can arbitrarily be combined.

The average particle diameter of the nickel-containing hydroxide particle covered with cobalt is not particularly limited, but, for example, the lower limit value of a particle diameter with a cumulative volume percentage of 50% by volume (D50) (hereinafter may be simply referred to as “D50”), is preferably 4.0 μm, more preferably 6.0 μm, and particularly preferably 9.0 μm, from the viewpoint of ensuring that the nickel-containing hydroxide particles are definitely prevented from aggregation when the cobalt covering of the nickel-containing hydroxide particle undergoes oxidation treatment. The upper limit value of D50 of the nickel-containing hydroxide particle covered with cobalt is, on the other hand, preferably 15.0 μm and particularly preferably 12.5 μm from the viewpoint of balance between improvements in the filling density and securing of a contact surface with an electrolytic solution. The lower limit values and the upper limit values described above can arbitrarily be combined. D50 of the nickel-containing hydroxide particle covered with cobalt can be measured, for example, upon measuring a volume-based particle size distribution by the laser diffraction scattering method.

The BET specific surface area of the nickel-containing hydroxide particle covered with cobalt is not particularly limited, but the lower limit value thereof is preferably 5.0 m²/g and particularly preferably 10.0 m²/g from the viewpoint of balance between improvements in density and securing of a contact surface with the electrolytic solution. The upper limit value of the BET specific surface area of the nickel-containing hydroxide particle covered with cobalt is, on the other hand, preferably 20.0 m²/g and particularly preferably 15.0 m²/g from the viewpoint of obtaining an excellent particle strength. The lower limit values and the upper limit values described above can arbitrarily be combined.

The tap density of the nickel-containing hydroxide particle covered with cobalt is not particularly limited, but is preferably 1.5 g/cm³ or more and particularly preferably 1.7 g/cm³ or more from the viewpoint of, for example, improvements in the filling degree in using the particle in a positive electrode as a positive electrode active material.

The bulk density of the nickel-containing hydroxide particle covered with cobalt is not particularly limited, but is preferably 0.8 g/cm³ or more, and particularly preferably 1.0 g/cm³ or more from the viewpoint of, for example, improvements in the filling degree in using the particle in a positive electrode as a positive electrode active material.

Thereafter, examples of a method for producing the nickel-containing hydroxide particle covered with cobalt of the present disclosure will be described.

Examples of the method for producing the nickel-containing hydroxide particle covered with cobalt of the present disclosure include a step of preparing a suspension (for example, a water suspension) containing the nickel-containing hydroxide particle that is the core particle, a covering step of supplying the suspension containing the nickel-containing hydroxide particle with a cobalt salt solution and an alkali solution and forming a covering layer containing cobalt on a surface of the nickel-containing hydroxide particle to obtain a nickel-containing hydroxide particle having the covering layer formed thereon, and an oxidation step of adding an alkali solution to the nickel-containing hydroxide particle having the covering layer formed thereon, mixing and heating them to oxidize the cobalt contained in the covering layer.

<Preparation Step of Suspension Containing Nickel-Containing Hydroxide Particle>

A method for preparing a suspension containing the nickel-containing hydroxide particle that is the core particle will be described below. Here, an example of a method for preparing a suspension containing a nickel-containing hydroxide particle in which zinc and additive metal element M are solid-solubilized in the particle will be described. First, a salt solution (for example, a sulfate solution) of nickel, zinc, and additive metal element M, added with nickel, zinc, and additive metal element M in a predetermined compounding ratio, and a complexing agent are reacted by a coprecipitation method to produce a nickel-containing hydroxide particle and to obtain a slurry suspension containing the nickel-containing hydroxide particle. As a solvent for the suspension, for example, water is used.

The complexing agent is not particularly limited as long as the complexing agent can form a complex with nickel, zinc, and an ion of additive metal element M described above in an aqueous solution, and examples thereof include, for example, ammonium ion-supplying bodies (such as ammonium sulfate, ammonium chloride, ammonium carbonate, and ammonium fluoride), hydrazine, ethylenediaminetetraacetic acid, nitrilotriacetic acid, uracildiacetic acid, and glycine. If necessary, an alkali metal hydroxide (for example, sodium hydroxide or potassium hydroxide) is added in order to adjust the pH value of the aqueous solution in performing coprecipitation.

When the above-described salt solution and the complexing agent are supplied continuously into a reaction tank, nickel, zinc and additive metal element M undergo crystallization reaction and the nickel-containing hydroxide particle is produced. In performing the crystallization reaction, the substances in the reaction tank are stirred appropriately while the temperature of a mother liquid in the reaction tank is controlled within the range of, for example, 10° C. to 80° C., preferably 20 to 70° C., and the pH value of the mother liquid in the reaction tank is controlled within the range of, for example, a pH of 9 to a pH of 13, preferably a pH of 11 to 13 at a liquid temperature of 25° C. as a standard. Examples of the reaction tank include a continuous type to allow the formed hydroxide particle containing nickel to overflow for the purpose of separation.

<Solid-Liquid Separation Treatment>

Thereafter, the suspension containing the nickel-containing hydroxide particle is separated into a solid phase and a liquid phase, and the solid phase separated from the liquid phase is dried to obtain dried powder of the nickel-containing hydroxide particles formed of the slurry suspension. Moreover, before drying the solid phase, the solid phase may be washed with weak alkaline water, if necessary.

<Covering Step>

Thereafter, the dried powder of the nickel-containing hydroxide particles and warm water at 45° C. are mixed and supplied into a reaction tank in a predetermined weight ratio, and subsequently fed with warm water so that the suspension reaches a predetermined concentration. Mixing preliminarily the dried powder and the warm water before the start of the reaction allows sufficient immersion of the warm water into the dried powder and facilitates reaction with a cobalt salt solution. The weight ratio of the dried powder and the warm water is not particularly limited, but the weight ratio is preferably 1.0:2.0, more preferably 1.0:2.5, and particularly preferably 1.0:3.0. Subsequently, the cobalt salt solution (for example, an aqueous solution of cobalt sulfate or the like) and an alkali solution (for example, a sodium hydroxide aqueous solution or the like) are added while stirring with a stirrer, forming a covering layer composed mainly of a cobalt compound such that a valence number of cobalt is 2, such as cobalt hydroxide, on a surface of the nickel-containing hydroxide particle by neutralization crystallization. In this case, ammonium ion-supplying bodies (for example, an ammonium sulfate solution or the like) may be added as complexing agents. The pH in the step of forming the above-described covering layer is preferably maintained in the range of 9 to 13 at a liquid temperature of 25° C. as a standard. The covering step above allows a nickel-containing hydroxide particle having a covering layer containing cobalt formed thereon to be obtained. The nickel-containing hydroxide particle having a covering layer containing cobalt formed thereon can be obtained as a slurry suspension.

<Solid Liquid Separation Treatment>

The suspension containing the nickel-containing hydroxide particle having a covering layer containing cobalt formed thereon is separated into a solid phase and a liquid phase, and the solid phase separated from the liquid phase is dried to enable to obtain dried powder of the nickel-containing hydroxide particle having a covering layer containing cobalt formed thereon from the slurry suspension. In addition, before drying the solid phase, the solid phase may be washed with weak alkaline water, if necessary.

<Oxidation Step>

Thereafter, an oxidation treatment is performed on the nickel-containing hydroxide particle having a covering layer containing cobalt formed thereon. Methods of the oxidation treatment include a method for adding an alkali solution such as a sodium hydroxide aqueous solution to the dried powder of the nickel-containing hydroxide particles having a covering layer containing cobalt formed thereon, mixing, and heating them. In this case, the mixture is preferably oxidized at 110° C. or higher, more preferably at 115° C. or higher, and particularly preferably at 120° C. or higher in order to evaporate water rapidly in the sodium hydroxide aqueous solution. Moreover, the oxidation treatment is preferably performed by preliminarily raising the nickel-containing hydroxide particle covered with cobalt to a temperature to 60° C., adding an alkali solution such as a sodium hydroxide aqueous solution, and then further heating the mixture. The above-described oxidation treatment allows water to evaporate rapidly, thereby enabling divalent cobalt in the nickel-containing hydroxide particle having a covering layer containing cobalt formed thereon to be oxidized efficiently to cobalt oxyhydroxide that is trivalent cobalt. Oxidation of the divalent cobalt in the covering layer to cobalt oxyhydroxide enables the nickel-containing hydroxide particle covered with cobalt of the present disclosure having a covering layer containing cobalt oxyhydroxide formed on the particle to be obtained.

In the nickel-containing hydroxide particle covered with cobalt of the present disclosure, adjusting mainly the oxidation conditions, such as the amount of an alkali solution added in the oxidation step allows a relative error between value A before compression treatment at a pressing pressure of 64 MPa and value B after compression treatment at a pressing pressure of 64 MPa to be controlled to −1.50 or more to 5.00 or less with respect to the area size of the region with ½ or higher the height of the maximum peak. Specifically, oxidation conditions in the oxidation step, set to the weight ratio of the nickel-containing hydroxide particle having a covering layer containing cobalt formed thereon and an alkali solution (the concentration is, for example, 32 to 48% by mass.) being 1:0.1, allows the relative error in the area size of the region with ½ or higher the height of the maximum peak to be −1.50 or more and 5.00 or less.

<Solid Liquid Separation Treatment>

Further, after the oxidation step, a step for separating a suspension containing the nickel-containing hydroxide particle covered with cobalt into a solid phase and a liquid phase, and drying the solid phase separated from the liquid phase, may be further included. In addition, before drying the solid phase, the solid phase may be washed with weak alkaline water, if necessary.

Thereafter, a positive electrode using the nickel-containing hydroxide particle covered with cobalt of the present disclosure and a secondary battery using the positive electrode will be described. Here, a nickel metal hydride secondary battery will be used as an example of the secondary battery. The nickel metal hydride secondary battery is provided with a positive electrode using the above-described nickel-containing hydroxide particle covered with cobalt of the present disclosure, a negative electrode, an alkaline electrolytic solution, and a separator.

The positive electrode is provided with a positive electrode collector and a positive electrode active material layer formed on a surface of the positive electrode collector. The positive electrode active material layer has the nickel-containing hydroxide particle covered with cobalt, a binder (binding agent), and, if necessary, a conductive assistant. The conductive assistant is not particularly limited as long as the conductive assistant can be used for a nickel metal hydride secondary battery, but, for example, metal cobalt, cobalt oxide, and the like can be used. The binder is not particularly limited, but examples thereof include polymer resins, such as, for example, polyvinylidene difluoride (PVdF), butadiene rubber (BR), polyvinyl alcohol (PVA), and carboxymethyl cellulose (CMC), polytetrafluoroethylene (PTFE), and combinations thereof. The positive electrode collector is not particularly limited, but examples thereof include a perforated metal, an expanded metal, wire netting, a foam metal such as, foam nickel, a mesh-like metal fiber sintered body, a metal-plated resin sheet, and a metal foil.

As a method for producing the positive electrode, for example, a positive electrode active material slurry is first prepared by mixing the nickel-containing hydroxide particle covered with cobalt, a binder, water and, if necessary, a conductive assistant. Subsequently, the positive electrode collector is filled with the positive electrode active material slurry by a known filling method, and the positive electrode active material slurry is dried, and then rolled and fixed with a press or the like.

The negative electrode is provided with a negative electrode collector and a negative electrode active material layer containing a negative electrode active material, the layer formed on a surface of the negative electrode collector. The negative electrode active material is not particularly limited as long as the negative electrode active material is usually used, and, for example, a hydrogen storage alloy particle can be used. As the negative electrode collector, electrically conductive metal materials, such as nickel, aluminum, and stainless steel, can be used.

Moreover, if necessary, a conductive assistant, a binder (binding agent), or the like may be further added in the negative electrode active material layer. Examples of the conductive assistant and the binder include the conductive assistants and the binders which are the same as those used in the positive electrode material layer.

As a method for producing the negative electrode, for example, a negative electrode active material slurry is first prepared by mixing a negative electrode active material, water, and if necessary, a conductive assistant and a binder. Subsequently, the negative electrode collector is filled with the negative electrode active material slurry by a known filling method, and the negative electrode active material slurry is dried, and then rolled and fixed with a press or the like.

In the alkaline electrolytic solution, examples of the solvent include water, and examples of the solute to be dissolved in the solvent include potassium hydroxide and sodium hydroxide. The solutes may be used singly, or two or more thereof may be used together.

The separator is not particularly limited, and examples thereof include polyolefin nonwoven fabric such as polyethylene nonwoven fabric and polypropylene nonwoven fabric, polyamide nonwoven fabric, and those obtained by performing a hydrophilic treatment thereon.

### EXAMPLES

Thereafter, Examples of the present disclosure will be described, but the present disclosure is not limited to these Examples unless deviating from the scope thereof.

### Example 1

Synthesis of Nickel-Containing Hydroxide Particle

An ammonium sulfate aqueous solution (complexing agent) and a sodium hydroxide aqueous solution were dropped into an aqueous solution obtained by dissolving zinc sulfate and nickel sulfate in a molar ratio of 2.0:98.0, and the resultant mixture was stirred continuously with a stirrer while the pH in the reaction tank was kept at 12.0 at a liquid temperature of 25° C. as a standard. A produced hydroxide was allowed to overflow from an overflow pipe of the reaction tank and was taken out. Each treatment of washing with water, dehydration, and drying was performed on the hydroxide which was taken out to obtain a nickel-containing hydroxide particle.

Formation of Covering Layer Containing Cobalt

Dried powder of the nickel-containing hydroxide particles obtained in the manner as described above and warm water at 45° C., were supplied into the reaction tank under mixing in a weight ratio of 1.0:2.0, and warm water was then put so that the suspension reached a predetermined concentration. After the nickel-containing hydroxide particle was put into the reaction tank, a cobalt sulfate aqueous solution the concentration of which was 90 g/L was dropped into the solution under stirring. A sodium hydroxide aqueous solution was dropped appropriately during the dropping to keep the pH of the reaction tank in the range of 9 to 13 at a liquid temperature of 25° C. as a standard to form a covering layer of cobalt hydroxide on a surface of the hydroxide particle, thereby obtaining a suspension of a nickel-containing hydroxide particle covered with cobalt hydroxide.

Oxidation Treatment on Nickel-Containing Hydroxide Particle Covered with Cobalt Hydroxide

The suspension of the nickel-containing hydroxide particle covered with cobalt hydroxide, which was obtained in the manner as described above, underwent solid liquid separation treatment followed by drying treatment of a solid phase to obtain dried powder of the nickel-containing hydroxide particles covered with cobalt hydroxide. Then, the nickel-containing hydroxide particle covered with cobalt hydroxide was raised to a temperature of 60° C., and then while further heated and stirred, a 48% by mass sodium hydroxide aqueous solution was supplied so that the weight ratio of the nickel-containing hydroxide particle covered with cobalt hydroxide and the alkali solution was 1:0.10 and heated at 120° C. for oxidation treatment. In the oxidation treatment above, the cobalt hydroxide in the covering layer of the nickel-containing hydroxide particle was oxidized to be cobalt oxyhydroxide that was trivalent cobalt.

Solid-Liquid Separation and Drying Treatment

Thereafter, each treatment of washing with water, dehydration, and drying was performed on the oxidation-treated nickel-containing hydroxide particle to obtain a nickel-containing hydroxide particle covered with cobalt of Example 1.

### Comparative Example 1

A nickel-containing hydroxide particle covered with cobalt of Comparative Example 1 was obtained in the same manner as in Example 1 except that a weight ratio of the nickel-containing hydroxide particle covered with cobalt hydroxide and the alkali solution was 1:0.05 in the oxidation treatment in Example 1.

### Comparative Example 2

A nickel-containing hydroxide particle covered with cobalt of Comparative Example 2 was obtained in the same manner as in Example 1 except that the weight ratio of the nickel-containing hydroxide particle covered with cobalt hydroxide and the alkali solution was 1:0.20 in the oxidation treatment in Example 1.

### Comparative Example 3

An aqueous solution obtained by dissolving cobalt sulfate as additive metal element M, zinc sulfate, and nickel sulfate in the molar ratio of 4.5:5.0:90.5 was used instead of an aqueous solution obtained by dissolving zinc sulfate and nickel sulfate in the molar ratio of 2.0:98.0. A nickel-containing hydroxide particle covered with cobalt of Comparative Example 3 was obtained in the same manner as in Example 1 except that warm water and dried powder were mixed from the beginning so that the suspension reached a predetermined concentration at the covering step, and the temperature upon the oxidation treatment was set to 100° C. at the oxidation step because additive metal element M was contained in large amount.

Evaluation Items

### (1) Measurement of Volume-Based Particle Size Distribution by Laser Diffraction Scattering Method

The volume-based particle size distributions of the nickel-containing hydroxide particles covered with cobalt, obtained in Example 1 and Comparative Examples 1 to 3 were measured before press by a laser diffraction scattering method with a particle size distribution measurement apparatus (LA-950, HORIBA, Ltd.) under the conditions of solvent: water, solvent refractive index: 1.33, particle refractive index: 2.13, transmittance: 80±5%, and dispersion medium: 10.0 wt % sodium hexametaphosphate aqueous solution, to obtain volume-based particle size distribution diagrams. Moreover, the volume-based particle size distributions of the nickel-containing hydroxide particles covered with cobalt, obtained in Example 1 and Comparative Examples 1 to 3 after the press, which had undergone compression treatment of putting 3.00 g of a sample into a sample feed cell with a radius of 10 mm and applying thereto a load of 20 kN (pressing pressure of 64 MPa) by using a compression press apparatus (Model MCP-PD51, Mitsubishi Chemical Analytec, Co., Ltd.), were measured by the laser diffraction scattering method with the particle size distribution measurement apparatus (LA-950, HORIBA, Ltd.) under the conditions of solvent: water, solvent refractive index: 1.33, particle refractive index: 2.13, transmittance: 80±5%, and dispersion medium: 10.0 wt % sodium hexametaphosphate aqueous solution, to obtain volume-based particle size distribution diagrams. Using each volume-based particle size distribution diagram before the press, value A that indicates the area size of the region before the press, with ½ or higher the height of the maximum peak was calculated according to formula (1). Moreover, using each volume-based particle size distribution diagram after the press, value B that indicates the area size of the region after the press, with ½ or higher the height of the maximum peak was calculated according to formula (2). Further, a relative error between value A and value B was calculated using formula (3).

(2) D50

D50 of the nickel-containing hydroxide particle covered with cobalt before the press was obtained from the results of the volume-based particle size distribution before the press measured by the laser diffraction scattering method described above in (1).

(3) Tap density (TD)

The tap density of the nickel-containing hydroxide particle covered with cobalt (before the press), obtained in each of Example 1 and Comparative Examples 1 to 3 was measured by a constant volume measurement method, which is one of the methods described in JIS R1628 by using a tap denser (“KYT-4000”, SEISHIN KIGYO Co., Ltd.).

(4) Bulk Density (BD)

The bulk density of the nickel-containing hydroxide particle covered with cobalt (before the press), obtained in each of Example 1 and Comparative Examples 1 to 3 was measured by dropping a sample spontaneously into a container and filling the container with the sample, using the volume of the container and the mass of the sample.

(5) BET Specific Surface Area

One gram of the nickel-containing hydroxide particle covered with cobalt (before the press), obtained in each of Example 1 and Comparative Examples 1 to 3 was dried at 105° C. for 30 minutes in a nitrogen atmosphere, and then the BET specific surface area of the nickel-containing hydroxide particle covered with cobalt was measured by a one-point BET method using a specific surface area analyzer (Macsorb, Mountech Co., Ltd.).

(6) Volume Resistivity

The volume resistivity (Ω·cm) of the nickel-containing hydroxide particles covered with cobalt (before the press), obtained in each of Example 1 and Comparative Examples 1 to 3 was measured under the following conditions by using a powder resistivity system (Loresta) MCP-PD51, manufactured by Mitsubishi Chemical Analytec Co., Ltd.

Probe used: Four-point probe
Electrode spacing: 3.0 mm
Electrode radius: 0.7 mm
Sample radius: 10.0 mm
Sample mass: 3.00 g
Applied pressure: 20 kPa

(7) Capacity Retention Rate

The nickel-containing hydroxide particles covered with cobalt (before the press), obtained in Example 1 and Comparative Examples 1 to 3 were activated by charging and discharging them at 0.2° C. for 8 cycles. The activated nickel-containing hydroxide particles covered with cobalt underwent high temperature exposure treatment where the particles were left at 50° C. for 10 days with a 10Ω resistance connected. The nickel-containing hydroxide particles covered with cobalt after the activation and the nickel-containing hydroxide particles covered with cobalt after the high temperature exposure treatment were charged and discharged at 0.2 C and the discharge capacities (P) of the nickel-containing hydroxide particles covered with cobalt after the activation and the discharge capacities (Q) of the nickel-containing hydroxide particles covered with cobalt after the high temperature exposure treatment were measured to calculate a capacity retention rate according to the formula of (discharge capacity (Q) of the nickel-containing hydroxide particle covered with cobalt after the high temperature exposure treatment/discharge capacity (P) of the nickel-containing hydroxide particle covered with cobalt after the activation×100).

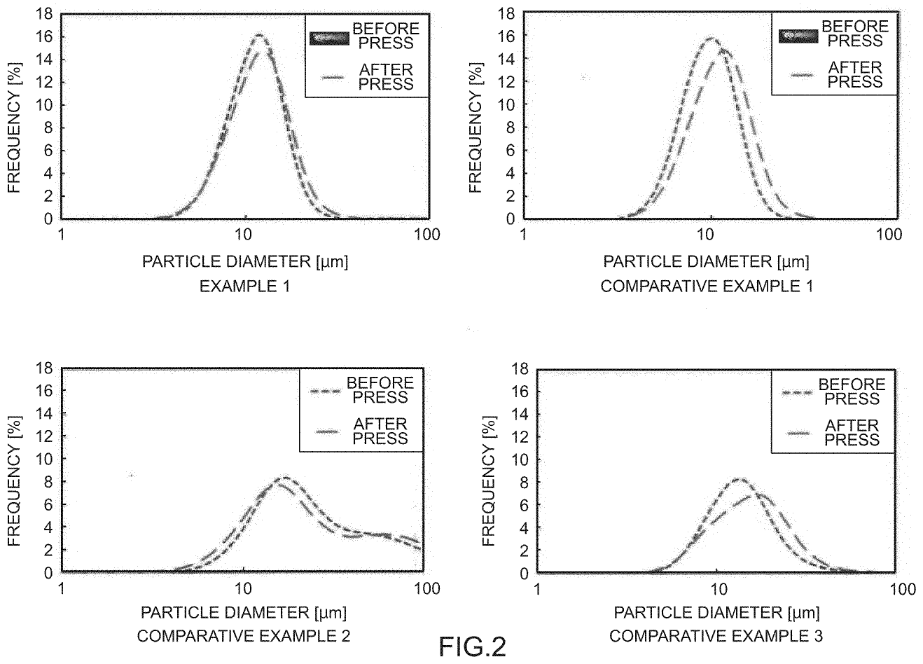

The volume-based particle size distribution diagrams of the nickel-containing hydroxide particles covered with cobalt of Example 1 and Comparative Examples 1 to 3, obtained by the laser diffraction scattering method, are shown in FIG. 2, values A calculated by formula (1) using the volume-based particle size distribution diagrams before the press, values B calculated by formula (2) using the volume-based particle size distribution diagrams after the press, and the relative errors between values A and values B calculated by formula (3), are shown in Table 1 below, along with D50, the tap densities (TD), bulk densities (BD), BET specific surface areas, volume resistivities, and capacity retention rates, which are shown in Table 2 below, respectively.

TABLE 1

| | | Compar- | Compar- | Compar- |
|---|---|---|---|---|
| | | ative | ative | ative |
| | Example 1 | Example 1 | Example 2 | Example 3 |
| Value A calculated by | 959 | 989 | 720 | 880 |
| formula (1) | | | | |
| Value B calculated by | 948 | 973 | 683 | 944 |
| formula (2) | | | | |
| Relative error ([(B − | −1.15 | −1.62 | −5.14 | 7.27 |
| A)/A] × 100) (%) | | | | |

TABLE 2

| | | | Compar- | Compar- | Compar- |
|---|---|---|---|---|---|
| | | | ative | ative | ative |
| | Unit | Example 1 | Example 1 | Example 2 | Example 3 |
| D50 | μm | 10.5 | 9.0 | 20.9 | 11.5 |
| Tap density | g/cm³ | 2.14 | 2.12 | 2.16 | 2.33 |
| (TD) | | | | | |
| Bulk density | g/cm³ | 1.45 | 1.49 | 1.52 | 1.70 |
| (BD) | | | | | |
| BET specific | m²/g | 11.4 | 12.6 | 14.4 | 11.6 |
| surface area | | | | | |
| Volume | Ω · cm | 0.82 | 1.30 | 2.60 | 67.5 |
| resistivity | | | | | |
| Capacity | % | 96.3 | 91.9 | 87.7 | 85.0 |
| retention rate | | | | | |
| ((Q/P) × 100) | | | | | |

From Tables 1 and 2 above, it was found that the nickel-containing hydroxide particle covered with cobalt of Example 1 having a composition with the ratio by molar % of nickel:zinc:additive metal element M of 100-x-y:x:y (where 1.50≤x≤9.00, 0.00≤y≤3.00), and the relative error between value of A indicating that the area size of the region before the press, with ½ or higher the height of the maximum peak, and value B indicating that the area size of the region after the press, with ½ or higher the height of the maximum peak, of −1.50 or more and 5.00 or less, had a volume resistivity of 0.82 Ω·cm, which was excellent in electrical conductivity. Therefore, Example 1 having the composition with the ratio by molar % of nickel:zinc:additive metal element M of 100-x-y:x:y (where 1.50 x≤x≤9.00, 0.00≤y≤3.00), was found to reduce the volume resistivity because when the cobalt covering of the nickel-containing hydroxide particle underwent oxidation treatment, the cobalt covering was sufficiently oxidized while the nickel-containing hydroxide particles were prevented from aggregation. Moreover, the nickel-containing hydroxide particle covered with cobalt of Example 1 had the capacity retention rate of 96.3% calculated from the discharge capacity after the activation and the discharge capacity after the high temperature exposure treatment, which was the excellent capacity retention rate even after having performed the high temperature exposure treatment. Therefore, a secondary battery mounted with the nickel-containing hydroxide particle covered with cobalt of Example 1 was found to exhibit excellent battery characteristics even when operated in severe environments such as high temperatures and under high load.

Further, the nickel-containing hydroxide particle covered with cobalt of Example 1 could obtain D50, tap density (TD), bulk density (BD), and BET specific surface area, which were all comparable to those of conventional products, thereby not impairing the properties except for the relative error before and after the press with respect to the area of the region with ½ or higher the height of the maximum peak, and the volume resistivity.

From Tables 1 and 2 above, on the other hand, it was found that the nickel-containing hydroxide particle covered with cobalt of Comparative Example 1, which underwent the oxidation treatment in the weight ratio of 1:0.05 of the nickel-containing hydroxide particle covered with cobalt hydroxide and the alkali solution, had the above-described relative error of −1.62 and the volume resistivity of 1.30 Ω·cm, not enabling the favorable electrical conductivity to be obtained. Therefore, Comparative Example 1 was found unable to reduce the volume resistivity because when the cobalt covering of the nickel-containing hydroxide particle underwent oxidation treatment, the cobalt covering was not sufficiently oxidized. Moreover, the nickel-containing hydroxide particle covered with cobalt of Comparative Example 1 had the capacity retention rate of 91.9% calculated from the discharge capacity after the activation and the discharge capacity after the high temperature exposure treatment, not enabling the favorable capacity retention rate to be obtained when performing the high temperature exposure treatment. Therefore, a secondary battery mounted with the nickel-containing hydroxide particle covered with cobalt of Comparative Example 1 was found unable to exhibit excellent battery characteristics when operated in severe environments such as high temperatures and under high load.

Further, the nickel-containing hydroxide particle covered with cobalt of Comparative Example 2, having undergone oxidation treatment in the weight ratio of 1:0.20 of the nickel-containing hydroxide particle covered with cobalt hydroxide and the alkali solution, had the above-described relative error of −5.14 and the volume resistivity of 2.60 Ω·cm, not enabling the favorable electrical conductivity to be obtained. Therefore, Comparative Example 2 was found unable to reduce the volume resistivity because when the cobalt covering of the nickel-containing hydroxide particle underwent oxidation treatment, the cobalt covering was sufficiently oxidized, however, the nickel-containing hydroxide particles facilitate aggregation. Moreover, the nickel-containing hydroxide particle covered with cobalt of Comparative Example 2 had the capacity retention rate of 87.7% calculated from the discharge capacity after the activation and the discharge capacity after the high temperature exposure treatment, not enabling the favorable capacity retention rate to be obtained when performing the high temperature exposure treatment.

Moreover, the nickel-containing hydroxide particle covered with cobalt of Comparative Example 3 having the ratio by molar % of nickel:zinc:additive metal element M of 90.5:5.0:4.5, exhibited the above-described relative error of 7.27 and the volume resistivity of 67.5 Ω·cm, not enabling the favorable electrical conductivity to be obtained. Comparative Example 3 having additive metal element M in an amount of 3.00 or more was considered to prevent the covering layer from being oxidized in the oxidation step, not enabling the volume resistivity to be sufficiently reduced. Further, the nickel-containing hydroxide particle covered with cobalt of Comparative Example 3 exhibited the capacity retention rate of 85.0% calculated from the discharge capacity after the activation and the discharge capacity after the high temperature exposure treatment, not enabling the favorable capacity retention rate to be obtained when performing the high temperature exposure treatment.

When the nickel-containing hydroxide particle covered with cobalt of the present disclosure is mounted on a nickel metal hydride secondary battery as a positive electrode active material, the secondary battery can operate under severe environments such as high temperatures and exhibit excellent battery characteristics even under high load, thereby enabling the secondary battery to be applied in all fields of nickel metal hydride secondary batteries.

What is claimed is:

1. A nickel-containing hydroxide particle covered with cobalt, comprising a covering layer comprising cobalt oxyhydroxide as a major component formed on a nickel-containing hydroxide particle,
wherein the nickel-containing hydroxide particle comprises nickel (Ni), zinc (Zn), and one or more additive metal elements M selected from the group consisting of cobalt (Co) and magnesium (Mg), and a ratio by molar % of nickel:zinc:additive metal element M is 100-x-y:x:y, where 1.50≤x≤9.00 and 0.00≤y≤3.00,
in a volume-based particle size distribution by a laser diffraction scattering method, the nickel-containing hydroxide particle covered with cobalt has the maximum peak with a height a, and one peak at a height of (½)a or higher, and has a value A of the following formula (1) calculated from a width b of the maximum peak at a height of (½)a, and
in a volume-based particle size distribution by the laser diffraction scattering method after compression treatment at a pressing pressure of 64 MPa, the nickel-containing hydroxide particle covered with cobalt has the maximum peak with a height c, and has a value B of the following formula (2) calculated from a width d of the maximum peak at a height of (½)c, and
wherein the value B and the value A have a relation represented by the following formula (3):
A=[(b×(½)a]/2 (1)
B=[(d×(½)c]/2 (2)
−1.50≤[(B−A)/A]×100≤5.00 (3)

2. The nickel-containing hydroxide particle covered with cobalt according to claim 1, having one peak in a volume-based particle size distribution before the compression treatment.

3. The nickel-containing hydroxide particle covered with cobalt according to claim 1, wherein a volume resistivity is 0.40 Ω·cm or higher and 1.20 Ω·cm or lower.

4. The nickel-containing hydroxide particle covered with cobalt according to claim 2, wherein a volume resistivity is 0.40 Ω·cm or higher and 1.20 Ω·cm or lower.

5. The nickel-containing hydroxide particle covered with cobalt according to claim 1, wherein the covering layer comprising cobalt oxyhydroxide further comprises cobalt oxide.

6. The nickel-containing hydroxide particle covered with cobalt according to claim 2, wherein the covering layer comprising cobalt oxyhydroxide further comprises cobalt oxide.

7. The nickel-containing hydroxide particle covered with cobalt according to claim 3, wherein the covering layer comprising cobalt oxyhydroxide further comprises cobalt oxide.

8. The nickel-containing hydroxide particle covered with cobalt according to claim 1, wherein the nickel-containing hydroxide particle comprises zinc.

9. The nickel-containing hydroxide particle covered with cobalt according to claim 2, wherein the nickel-containing hydroxide particle comprises zinc.

10. The nickel-containing hydroxide particle covered with cobalt according to claim 3, wherein the nickel-containing hydroxide particle comprises zinc.

11. The nickel-containing hydroxide particle covered with cobalt according to claim 5, wherein the nickel-containing hydroxide particle comprises zinc.

12. The nickel-containing hydroxide particle covered with cobalt according to claim 1, which is for a positive electrode active material of a nickel metal hydride secondary battery.

13. A positive electrode having the nickel-containing hydroxide particle covered with cobalt according to claim 1 and a metal foil current collector.

14. A nickel metal hydride secondary battery comprising the positive electrode according to claim 13.
